(19) United States
(12) Patent Application Publication
(10) Pub. No.: US 2015/0082601 A1
(43) Pub. Date: Mar. 26, 2015

(54) CRIMPING APPARATUS

(71) Applicants: Srinivas Dutt, Land O Lakes, FL (US); Niroo Dutt, Land O Lakes, FL (US); Anisha Dutt, Land O Lakes, FL (US); Nikhil Dutt, Land O Lakes, FL (US)

(72) Inventors: Srinivas Dutt, Land O Lakes, FL (US); Niroo Dutt, Land O Lakes, FL (US); Anisha Dutt, Land O Lakes, FL (US); Nikhil Dutt, Land O Lakes, FL (US)

(21) Appl. No.: 14/496,637

(22) Filed: Sep. 25, 2014

Related U.S. Application Data
(60) Provisional application No. 61/882,167, filed on Sep. 25, 2013.

(51) Int. Cl. B25C 5/02; F16B 15/00; B25C 7/00

(52) U.S. Cl. CPC B25C 5/0207; B25C 7/00; F16B 15/00
USPC 29/432; 428/137

(57) ABSTRACT

A crimping apparatus to attach objects to materials using malleable fasteners is provided. The crimping apparatus may include a crimping platform. The crimping platform includes cutout portions and retaining bars forming a crimping pattern. The crimping platform is permanently affixed to an object. A material may be attached to the object by using malleable fasteners that protrude through the material and conform to the crimp platform.

### CROSS-REFERENCE TO RELATED APPLICATION

This application claims the benefit of priority of U.S. provisional application No. 61/882,167, filed Sep. 25, 2013, the contents of which are herein incorporated by reference.

### BACKGROUND OF THE INVENTION

The present invention relates to a crimping apparatus and, more particularly, to a crimping apparatus that attaches objects to materials using a malleable fastener.

Currently, there are limitations to attaching objects to various materials as well as limitations of materials that allow attachment. Attaching objects can be difficult and time consuming. Further, the attachment can be weak and at other times be difficult to separate when needed. An example is adhesives which do not adhere to many objects and materials. The resulting attachment can be very weak or conversely very difficult to separate without causing damage. Mechanical attachment such as screws may not work on many materials or objects.

As can be seen, there is a need for an improved crimping apparatus that attaches objects to materials using a malleable fastener.

### SUMMARY OF THE INVENTION

In one aspect of the present invention, a crimping apparatus comprises: a crimping platform comprising a top surface and a bottom surface, wherein the top surface comprises at least one cut out portion comprising an inner surface and at least one retaining bar extending over the at least one cut out portion, forming a gap in between the at least one retaining bar and the inner surface.

In another aspect of the present invention, a method of attaching materials to objects comprises: providing a crimping platform comprising a top surface and a bottom surface, wherein the top surface comprises two cut out portions, each comprising an inner surface, and two retaining bars extending over the at least one cut out portion, forming a gap in between each of the retaining bars and the inner surfaces; permanently affixing the bottom surface of the crimping platform to an object; placing a material over the top surface of the crimping platform; and stapling a staple into the crimping platform so that the ends of the staple bend around the two retaining bars, thereby securing the staple to the crimping platform.

These and other features, aspects and advantages of the present invention will become better understood with reference to the following drawings, description and claims.

### BRIEF DESCRIPTION OF THE DRAWINGS

FIG. 1 is a perspective view of the present invention, shown in use;

FIG. 2 is a perspective view of the present invention;

FIG. 3 is an exploded view of the present invention;

FIG. 4 is an exploded view of the present invention;

FIG. 5 is a section view of the present invention, taken along line 5-5 in FIG. 2;

FIG. 6 is a perspective view of the present invention, illustrating the placement of the material onto the crimping platform for insertion into a stapler;

FIG. 7 is a section view of the present invention, taken along line 7-7 in FIG. 1, with the upper portion of the stapler not shown for clarity;

FIG. 8 is a section view of the present invention, illustrating the initial insertion of the malleable fastener;

FIG. 9 is a section view of the present invention, illustrating the crimping of the malleable fastener; and

FIG. 10 is a section view of the present invention, with a crimped fastener attaching the material to the object.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a crimp platform apparatus to attach objects using malleable fasteners, such as staples. The present invention attaches objects to other materials using malleable fasteners that conform to the crimp platform and thus lock it in place. This allows a large variety of objects to be attached to a large variety of materials. This apparatus creates an attachment in a process that is easy and rapid. The created attachment is strong but can be easily separated if needed.

The platform with the crimp pattern may be built into the back side of an object. The platform with the crimp pattern can also be created separately and applied to the object using different methods, including adhesives. The platform with the reverse crimp pattern may be placed on the opposite side of the object. This reverse crimp pattern may stabilize and align the object when it is situated on a surface that conforms to its shape, such as a stapler crimp platform. The material that the object is to attach to is applied over the crimp pattern. This material can vary and can include paper, cloth, rubber, and plastic. A malleable fastener, such as a staple, can then be applied on the crimp pattern using a common device, such as a stapler. This malleable staple goes through the material and then contacts the platform and conforms to the crimp pattern. The malleable staple is firmly attached to the platform due to the specific crimp pattern that holds it in place and does not allow the staple to be released. The object, which has the crimp platform built into it or applied to it, is thus firmly attached to the material. The platform with the reverse crimp pattern can then be removed from the other, front side of the object. This reveals the full face of the object, which is now firmly attached to the material.

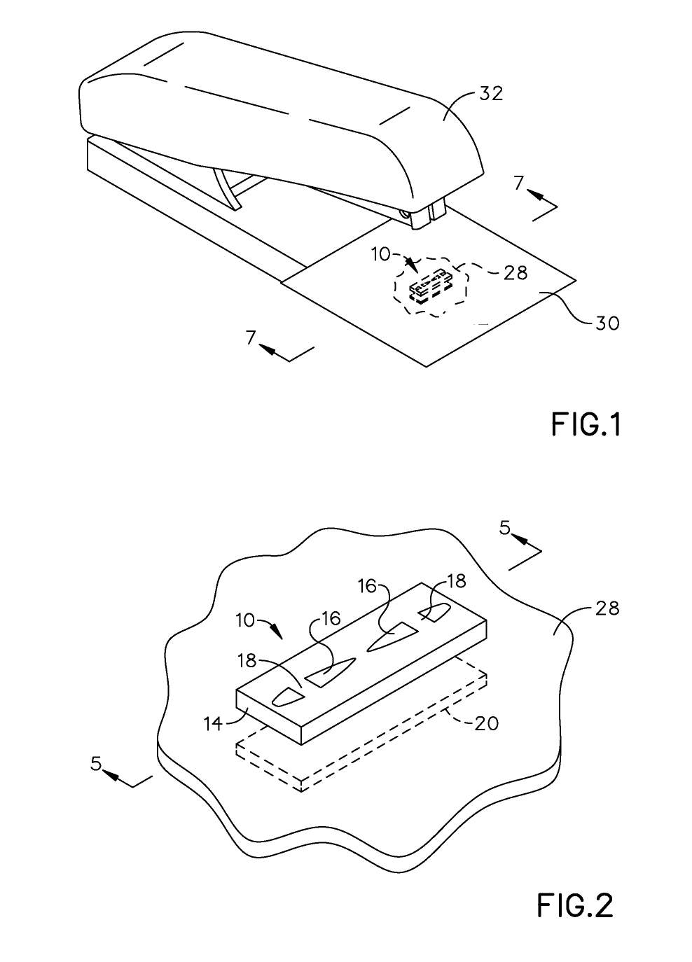

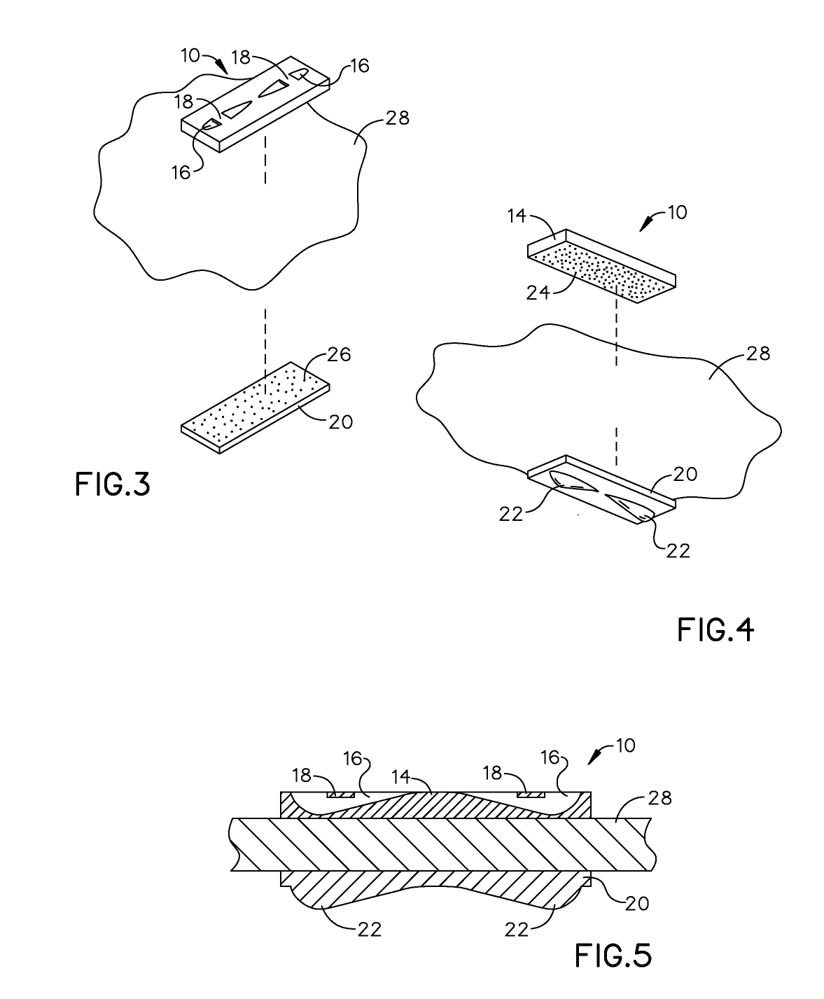

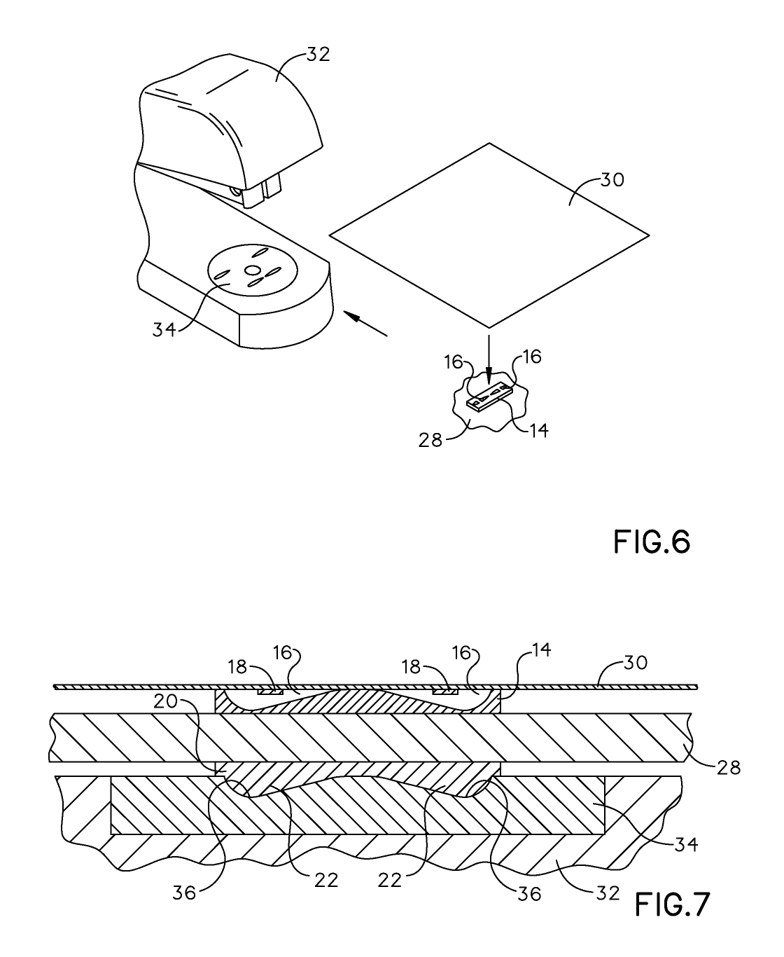

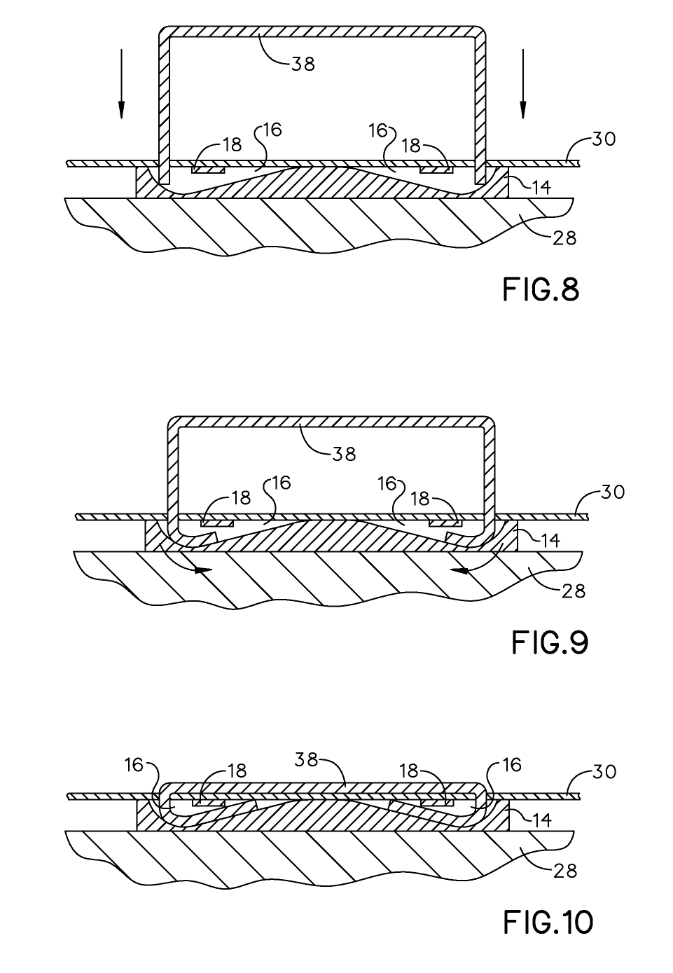

Referring to FIGS. 1 through 10, the present invention includes a crimping apparatus 10. The crimping apparatus 10 includes a crimping platform 14. The crimping platform 14 includes a top surface and a bottom surface. The top surface may include at least one cut out portion 16, such as two cutout portions 16. The cut out portions 16 may include an inner surface. A retaining bar 18 may extend over each of the cut out portions 16 forming a gap in between the retaining bar 18 and the inner surface of the cut out portion 16.

The crimping apparatus 10 may be used to attach an object 28 to a material 30. The bottom surface of the crimping platform 14 may be permanently affixed to the object 28. In certain embodiments, the object 28 may be manufactured with the crimping platform 14. Alternatively, the crimping platform 14 may be adhered to the object 28 by a permanent adhesive 24. The material 30, such as paper, cloth, rubber, and the like may be placed over the cut out portions 16. A malleable fastener, such as a staple 38 may puncture the material 30 and enter the cutout portions 16.

The cut out portions 16 of the present invention may be sized to receive the ends of the staple 38. The staple 38 is applied to the crimping platform 14 using a stapler 32. The malleable staple 38 goes through the material 30 and then contacts the inner surface of the crimping platform 14. The staple 38 conforms to the crimp pattern, i.e. the inner surface of the cutout portions 16 and the retaining bars 18. The malleable staple 38 is firmly attached to the platform 14 due to the retaining bars 18 that holds it in place and does not allow the staple 38 to be released. The object 28, which has the crimping platform 14 built into it or applied to it, is thus firmly attached to the material 30.

In certain embodiments, the present invention may further include a stabilizer platform 20. The stabilizer platform 20 may include a top surface and a bottom surface. The bottom surface may include at least one stabilizer nub 22, such as two stabilizer nubs 22. The stabilizer nubs 22 are sized to fit within a stapler crimp plate cavity 36 of a stapler crimp plate 34. The top surface of the stabilizer platform 20 may include a temporary adhesive 26 and may be temporarily attached to the object 28 on the opposite side of the crimping platform 10. When in use, the stabilizer nubs 22 may be placed within the stapler crimp plate cavity 36 to stabilize and align the crimping apparatus 10. A user may then easily staple into the crimping platform 14.

A method of using the present invention may include the following. Determine the object that is to be attached. The platform with the crimp pattern is placed on the back side of the object. It can be placed with strong adhesive, screwed into the object, or be built into the object. The reverse crimp platform is placed on the other side of the object using a temporary adhesive. The reverse crimp platform is aligned with the crimp platform base of a stapler to achieve stabilization and alignment. A material that is to be attached to the object, such as paper, is selected. It can be any material that can be penetrated by a malleable fastener, such as a staple or have openings to allow this. The material is placed over the platform with the crimp pattern, with its front side facing the crimp pattern. Using the stapler, a staple is applied through the paper and proceeds to the crimp platform where it is reshaped and conforms to the crimp pattern. Due to the crimp pattern, the staple remains securely attached. The object may be removed from the stapler. The object is now securely attached to the front side of the paper. The reverse crimp platform is no longer needed and is removed, revealing the complete face of the object. The back side of the paper reveals the staple. A staple remover can be applied here to remove the staple which comes out of the crimp pattern, and thus removes the attachment to the object. The object can thus be easily separated from the paper.

The platforms and crimp patterns can be made with different materials and may be used for different functions. For example, the materials may include tissue, plastics, woods, metals, electronics, and cloth. The crimp pattern can be varied to create different types of fixation. Mechanical or mobile elements could be used to provide a variety of functions. Different colors, sizes, styles, and shapes of the various components can be used for different purposes. Different malleable materials can be used for different functions. The above can also be modified and reconfigured to create the same or similar functions. The present invention may be used in the construction, healthcare, manufacturing, education, marketing, and related fields, as well as common, everyday uses.

It should be understood, of course, that the foregoing relates to exemplary embodiments of the invention and that modifications may be made without departing from the spirit and scope of the invention as set forth in the following claims.

What is claimed is:

1. A crimping apparatus comprising:
a crimping platform comprising a top surface and a bottom surface, wherein the top surface comprises at least one cut out portion comprising an inner surface and at least one retaining bar extending over the at least one cut out portion, forming a gap in between the at least one retaining bar and the inner surface.

2. The crimping apparatus of claim 1, wherein the at least one cut out portion comprises a first cut out portion and a second cut out portion.

3. The crimping apparatus of claim 2, wherein the at least one retaining bar comprises a first retaining bar extending over the first cut out portion, and a second retaining bar extending over the second cut out portion.

4. The crimping apparatus of claim 1, wherein the at least one cut out portion is sized an end of a staple.

5. The crimping apparatus of claim 1, wherein the bottom surface of the crimping platform is permanently affixed to an object.

6. The crimping apparatus of claim 5, wherein the bottom surface is permanently affixed by a permanent adhesive.

7. The crimping apparatus of claim 1, further comprising a stabilizer platform comprising a top surface and a bottom surface, wherein the bottom surface comprises at least one stabilizer nub sized to fit within a stapler crimp plate cavity.

8. The crimping apparatus of claim 6, wherein the at least one stabilizer nub is a first stabilizer nub and a second stabilizer nub.

9. The crimping apparatus of claim 6, wherein the top surface comprises a temporary adhesive.

10. A method of attaching materials to objects comprising:
providing a crimping platform comprising a top surface and a bottom surface, wherein the top surface comprises two cut out portions, each comprising an inner surface, and two retaining bars extending over the at least one cut out portion, forming a gap in between each of the retaining bars and the inner surfaces;
permanently affixing the bottom surface of the crimping platform to an object
placing a material over the top surface of the crimping platform; and
stapling a staple into the crimping platform so that the ends of the staple bend around the two retaining bars, thereby securing the staple to the crimping platform.

11. The method of claim 9, further comprising the steps of:
providing a stabilizer platform comprising a top surface and a bottom surface, wherein the bottom surface comprises two stabilizer nubs;
temporarily adhering the bottom surface of the stabilizer platform to an opposite side of the object; and
placing the two stabilizer nubs within stapler crimp plate cavities prior to stapling the staple into the crimping platform.
